(19) United States
(12) Patent Application Publication
(10) Pub. No.: US 2019/0347546 A1
(43) Pub. Date: Nov. 14, 2019

(54) METHOD, SYSTEM AND COMPUTER DEVICE FOR CONVERTING NEURAL NETWORK INFORMATION

(71) Applicant: TSINGHUA UNIVERSITY, Beijing (CN)

(72) Inventors: Jing PEI, Beijing (CN); Luping SHI, Beijing (CN); Zhenzhi WU, Beijing (CN); Guoqi LI, Beijing (CN); Lei DENG, Beijing (CN)

(73) Assignee: TSINGHUA UNIVERSITY, Beijing (CN)

(21) Appl. No.: 16/520,792

(22) Filed: Jul. 24, 2019

Related U.S. Application Data
(63) Continuation of application No. PCT/CN2017/114660, filed on Dec. 5, 2017.

(30) Foreign Application Priority Data
Jan. 25, 2017 (CN) 201710056188.5
Jan. 25, 2017 (CN) 201710056200.2
Jan. 25, 2017 (CN) 201710056211.0

(51) Int. Cl. G06N 3/063

(52) U.S. Cl. CPC G06N 3/063

(57) ABSTRACT

The present disclosure relates to a method, system and computer device for converting neural network information. The method comprises receiving neuron input information input by a preceding neuron, comprising receiving artificial neuron input information input by a preceding artificial neuron or receiving spiking neuron input information input by a preceding spiking neuron; converting the artificial neuron input information into spiking neuron conversion information through a preset artificial information conversion algorithm according to the artificial neuron input information input by the preceding artificial neuron; or converting the spiking neuron input information into artificial neuron conversion information through a preset spiking information conversion algorithm according to the spiking neuron input information input by the preceding spiking neuron; and outputting the spiking neuron conversion information or the artificial neuron conversion information. The present disclosure realizes the compatibility of two different neuron information in one neural network and improves the information processing capability of the neural network.

### CROSS-REFERENCE TO RELATED PATENT APPLICATIONS

The present application is a continuation of International Application No. PCT/CN2017/114660, filed Dec. 5, 2017, which claims the benefit of priority to Chinese Application No. CN 20170056211.0, 20170056188.5, and 20170056200.2, filed on Jan. 25, 2017, the content of which is incorporated herein by reference in its entirety.

### FIELD OF THE INVENTION

The present disclosure relates to the field of neuromorphic engineering technology, in particular, to method, system and computer device for converting neural network information.

### BACKGROUND

Most of today's artificial neural network research is still implemented by means of von Neumann's computer software with high-performance GPGPU (General Purpose Graphic Processing Units) platform, and the hardware overhead, energy consumption and information processing speed of the whole process is not optimistic. To this end, a tremendous development has been made in the field of neuromophic computing in recent years, that is, the use of hardware circuits to directly construct neural networks to simulate the function of the brain, trying to achieve a massively parallel and low energy consumption computing platform that can support complex mode learning.

However, there are two main forms of neural networks in traditional neuromorphic system: spiking neural network (SNN) and artificial neural network (ANN). The two neural networks have different ways of expression for the same input information, which results in incompatibility between the artificial neural network and the spiking neural network due to different information to be processed. Especially in neuromorphic circuit and system design, the incompatibility problem become a bottle neck.

### SUMMARY OF THE INVENTION

Based on this, it is necessary to provide a method, system and computer device for converting neural network information with respect to the problem of incompatibility of the information input by the two different neural networks.

A method for converting neural network information comprising:

receiving neuron input information input by a preceding neuron, comprising receiving artificial neuron input information input by a preceding artificial neuron or receiving spiking neuron input information input by a preceding spiking neuron;

converting the artificial neuron input information into spiking neuron conversion information through a preset artificial information conversion algorithm according to the artificial neuron input information input by the preceding artificial neuron; and

outputting the spiking neuron conversion information; or

converting the spiking neuron input information into artificial neuron conversion information through a preset spiking information conversion algorithm according to the spiking neuron input information input by the preceding spiking neuron, and

outputting the artificial neuron conversion information.

In one embodiment, converting the artificial neuron input information into spiking neuron conversion information through a preset artificial information conversion algorithm according to the artificial neuron input information input by the preceding artificial neuron comprising:

determining an input mode of the artificial neuron input information;

converting the artificial neuron input information into a first spiking neuron conversion information by using a first conversion mode when the input mode is a continuous input mode, wherein outputting the spiking neuron conversion information comprising outputting the first spiking neuron conversion information; and

converting the artificial neuron input information into a second spiking neuron conversion information by using a second conversion mode when the input mode is a single input mode, wherein outputting the spiking neuron conversion information comprising outputting the second spiking neuron conversion information.

In one embodiment, converting the artificial neuron input information into a first spiking neuron conversion information by using a first conversion mode when the input mode is a continuous input mode comprising:

dividing a first time window into a plurality of time steps at an equal interval;

emitting, in a first time step of the first time window, pulse spike information when the artificial neuron input information is greater than or equal to a preset spiking emission threshold and obtaining neuron post-emission information according to the artificial neuron input information and a preset emission decrement value; and emitting no pulse spike information when the artificial neuron input information is less than the preset spiking emission threshold and determining the artificial neuron input information as neuron non-emission information;

determining the neuron post-emission information or the neuron non-emission information as neuron intermediate information in the first time step;

determining, in subsequent time steps of the first time window, whether the pulse spike information is emitted according to the artificial neuron input information, the neuron intermediate information in a preceding time step, the preset spiking emission threshold and the preset emission decrement value respectively; and

determining all the pulse spike information emitted in the first time window as the first spiking neuron conversion information.

In one embodiment, determining whether the pulse spike information is emitted according to the artificial neuron input information, the neuron intermediate information in a preceding time step, the preset spiking emission threshold and the preset emission decrement value respectively comprising:

accumulating the artificial neuron input information and the neuron intermediate information in the preceding time step to obtain neuron accumulation information in current time step;

emitting the pulse spike information when the neuron accumulation information in the current time step is greater than or equal to the preset spiking emission threshold, and subtracting the preset emission decrement value from the neuron accumulation information in the current time step to obtain neuron post-emission information in the current time step; and

emitting no pulse spike information when the neuron accumulation information in the current time step is less than the preset spiking emission threshold and determining the neuron accumulation information in the current time step as neuron non-emission information in the current time step.

In one embodiment, converting the artificial neuron input information into a second spiking neuron conversion information by using a second conversion mode when the input mode is a single input mode comprising:

determining a fourth duration in a second time window according to the artificial neuron input information and the second time window; and

emitting the pulse spike information in the fourth duration and determining all the pulse spike information in the second time window as the second spiking neuron conversion information.

In one embodiment, emitting the pulse spike information in the fourth duration comprising:

continuously emitting the pulse spike information in the fourth duration.

In one embodiment, converting the spiking neuron input information into the artificial neuron conversion information through the preset spiking information conversion algorithm according to the spiking neuron input information comprising:

obtaining a conversion time step;

receiving, in the duration of the conversion time step, the spiking neuron input information input by the preceding spiking neuron, wherein the spiking neuron input information comprising the pulse spike information;

obtaining the artificial neuron conversion information through the preset spiking conversion algorithm according to the pulse spike information input by the preceding spiking neuron; and

outputting the artificial neuron conversion information.

In one embodiment, obtaining the artificial neuron conversion information through the preset spiking conversion algorithm according to the pulse spike information input by the preceding spiking neuron comprising:

accumulating the number of the pulse spike information input by the preceding spiking neuron to obtain a first total number of the pulse spike information input by the preceding spiking neuron; and

determining the first total number of the pulse spike information input by the preceding spiking neuron as a first artificial neuron conversion information for the spiking neuron input information input by the preceding spiking neuron in the time step.

In one embodiment, receiving the spiking neuron input information input by the preceding spiking neuron further comprising:

receiving the spiking neuron input information respectively input by at least two preceding spiking neurons;

wherein obtaining the artificial neuron conversion information through the preset spiking conversion algorithm according to the pulse spike information input by the preceding spiking neuron further comprising:

accumulating the number of pulse spike information input by all the preceding spiking neurons to obtain a second total number of pulse spike information input by all the preceding spiking neurons; and

determining the second total number of pulse spike information input by all the preceding spiking neurons as a second artificial neuron conversion information for the spiking neuron input information input by all the preceding spiking neurons in the time step.

In one embodiment, the spiking neuron input information further comprising:

a connection weight index of the preceding spiking neuron and the current neuron;

wherein obtaining the artificial neuron conversion information through the preset spiking conversion algorithm according to the pulse spike information input by the preceding spiking neuron further comprising:

reading the connection weight information of the preceding spiking neuron and the current neuron according to the connection weight index of the preceding spiking neuron and the current neuron;

obtaining weighted pulse spike information of the preceding spiking neuron according to the connection weight information of the preceding spiking neuron and the current neuron and the pulse spike information input by the preceding spiking neuron; and

obtaining a third artificial neuron conversion information through the preset spiking conversion algorithm according to the weighted pulse spike information of the preceding spiking neuron.

In one embodiment, by determining the input mode of the received artificial neuron input information input by the preceding artificial neuron, the artificial neuron input information input in the continuous input mode or the single input mode are respectively converted into the spiking neuron information by using different conversion modes. In this embodiment, not only the artificial neuron input information can be converted into the spiking neuron information, but also the different input modes of the artificial neuron input information can be compatible, which improves the compatibility of the neural network with the artificial neuron input information and the spiking neuron input information.

In one embodiment, when the input mode of the artificial neuro input information is the continuous input mode, the time window is divided into time steps at an equal interval, and whether the pulse spike information is emitted is determined according to the comparison of the artificial neuron input information and the spiking emission threshold in the first time step and the neuron intermediate information in the first time step is obtained. In subsequent respective time steps, whether the pulse spike information is emitted is determined according to the artificial neuron input information, the spiking emission threshold and the emission decrement value. Finally, all the pulse spike information emitted in the time window is determined as the converted spiking neuron information. By the way of controlling whether the pulse spike signal is emitted according to the artificial neuron input information by using the spiking emission threshold and the emission decrement value in the time window, different spiking neuron information conversion results can be given with respect to the artificial neuron input information by adjusting the spiking emission threshold and the emission decrement value according to different requirements, which can be easily implemented.

In one embodiment, the duration in which the pulse spike information is emitted in a time window is determined according to the artificial neuron input information and the spiking neuron conversion information is determined according to the emitted pulse spike information. In the embodiment, the spiking neuron conversion information is determined by the number of the pulse spike information in a certain time window or the ratio of the duration in which the pulse spike information is emitted to the duration in the time window in which no pulse spike information is emitted, which can be easily implemented.

In one embodiment, by acquiring the conversion time step, the spiking neuron input information is converted to the artificial neuron information according to received pulse spike information input by the preceding spiking neuron in different durations of the time steps and the preset spiking conversion algorithm. The method for converting the spiking neuron information into the artificial neuron information provided in this embodiment converts the spiking neuron information into the artificial neuron information by setting a time step, thereby improving the compatibility of the neural network with the spiking neuron information and the artificial neuron information.

In one embodiment, the spiking neuron input information input by the preceding spiking neuron information is converted into the artificial neuron conversion information by accumulating the number of pulse spike information in the conversion time step, the implementation is simple and reliable and the conversion efficiency is high.

In one embodiment, with respect to the spiking neuron input information input by a plurality of preceding spiking neurons, the artificial neuron conversion information for the spiking neuron input information input by the plurality of preceding spiking neurons are obtained by respectively converting the spiking neuron input information input by a single preceding spiking neuron into the artificial neuron conversion information, so that the current neuron may be used for subsequent calculations. The way of respectively converting the spiking neuron input information input by a single preceding spiking neuron into the artificial neuron conversion information is suitable for the situation where the number of the preceding spiking neurons is not too large, and the artificial neuron conversion information for the converted single preceding spiking neuron does not have any influence on the calculation for the current neurons.

In one embodiment, with respect to the spiking neuron input information input by a plurality of preceding spiking neurons, the spiking neuron input information input by all the preceding spiking neurons is accumulated and the accumulated spiking neuron input information is converted to obtain artificial neuron conversion information for the spiking neuron input information input by all the preceding spiking neurons. The way of accumulating the spiking neuron input information input by all the preceding spiking neurons and converting the accumulated spiking neuron input information into the artificial neuron conversion information for one time is suitable for the situation where there are a large number of preceding spiking neurons, which can improve the efficiency of converting the spiking neuron input information into the artificial neuron conversion information.

In one embodiment, the received preceding spiking neuron input information respectively carries a connection weight index. With respect to the spiking neuron input information carrying the connection weight index input by the plurality of preceding spiking neurons, the pulse spike information input by the single preceding spiking neuron is calculated with its connection weight information to obtain the artificial neuron conversion information for the spiking neuron input information input by the single preceding spiking neuron, which can ensure that the information conversion process does not influence the final calculation.

In one embodiment, a method for converting spiking neural network information into artificial neural network information comprising:

obtaining a conversion time step;

receiving, in the duration of the conversion time step, spiking neuron input information input by a preceding spiking neuron, wherein the spiking neuron input information comprising pulse spike information;

obtaining artificial neuron conversion information through a preset spiking conversion algorithm according to the pulse spike information input by the preceding spiking neuron; and

outputting the artificial neuron conversion information.

In one embodiment, a method for converting artificial neuron information into spiking neuron information comprising:

receiving artificial neuron input information input by a preceding artificial neuron;

determining an input mode of the artificial neuron input information;

converting the artificial neuron input information into a first spiking neuron information by using a first conversion mode when the input mode is a continuous input mode, and outputting the first spiking neuron information; and

converting the artificial neuron input information into a second spiking neuron information by using a second conversion mode when the input mode is a single input mode, and outputting the second spiking neuron information.

A computer device comprising a memory, a processor, and a computer program stored on the memory and operable on the processor, the processor executing the computer program to implement the steps of the method described in any of the above embodiments.

The present disclosure further provides a system for converting neural network information comprising:

a neuron input information acquiring module configured to receive neuron input information input by a preceding neuron, comprising receiving artificial neuron input information input by a preceding artificial neuron or receiving spiking neuron input information input by a preceding spiking neuron;

an artificial-spiking conversion module configured to convert the artificial neuron input information into spiking neuron conversion information through a preset artificial information conversion algorithm according to the artificial neuron input information input by the preceding artificial neuron;

a neuron conversion information output module configured to output the spiking neuron conversion information; or

a spiking-artificial conversion module configured to convert the spiking neuron input information into artificial neuron conversion information through a preset spiking information conversion algorithm according to the spiking neuron input information input by the preceding spiking neuron, and

wherein the neuron conversion information output module configured to output the artificial neuron conversion information.

In one embodiment, it is provided a system for converting spiking neural network information into artificial neural network information comprising:

a conversion time step acquiring module configured to obtain a conversion time step;

a spiking neuron input information acquiring module configured to receive, in the duration of the conversion time step, spiking neuron input information input by a preceding spiking neuron, wherein the spiking neuron input information comprising pulse spike information;

an artificial neuron conversion information acquiring module configured to obtain artificial neuron conversion information through a preset spiking conversion algorithm according to the pulse spike information input by the preceding spiking neuron; and

an artificial neuron conversion information output module configured to output the artificial neuron conversion information.

In one embodiment, it is provided a system for converting artificial neuron information into spiking neuron information comprising:

an artificial neuron input information receiving module configured to receive artificial neuron input information input by a preceding artificial neuron;

an input mode determining module configured to determine an input mode of the artificial neuron input information;

a first conversion module configured to convert the artificial neuron input information into a first spiking neuron information by using a first conversion mode when the input mode is a continuous input mode,

a spiking neuron information output module configured to output the first spiking neuron information; and

a second conversion module configured to convert the artificial neuron input information into a second spiking neuron information by using a second conversion mode when the input mode is a single input mode,

wherein the piking neuron information output module configured to output the second spiking neuron information.

The above method, system and computer device for converting neural network information convert the artificial neuron information into the spiking neuron information or convert the spiking neuron information into the artificial neuron information through a preset conversion algorithm according to received neural network information upon demand, which realizes the compatibility of two different neuron information in one neural network and improves the information processing capability of the neural network.

### BRIEF DESCRIPTION OF THE DRAWINGS

In order to clearly explain the technical solutions of the present disclosure, the drawings to be used in the embodiments will be briefly described below. Obviously, the drawings described below only illustrate some embodiments of the present disclosure, and those skilled in the art can obtain other drawings based thereon without paying any creative work.

FIG. 1 is a schematic flowchart of a method for converting neural network information according to an embodiment;

FIG. 2 is a schematic flowchart of a method for converting neural network information according to an embodiment;

FIG. 3 is a schematic flowchart of a method for converting neural network information according to another embodiment;

FIG. 4 is a schematic flowchart of a method for converting neural network information according to an embodiment;

FIG. 5 is a schematic flowchart of a method for converting neural network information according to another embodiment;

FIG. 6 is a schematic structural diagram of a computing core for implementing the method for converting neural network information according to an embodiment;

FIG. 7 is a schematic diagram of a first spiking neuron conversion information in the method for converting neural network information according to another embodiment;

FIG. 8 is a schematic diagram of a second spiking neuron conversion information in the method for converting neural network information according to another embodiment;

FIG. 9 is a schematic flowchart of a method for converting neural network information according to an embodiment;

FIG. 10 is a schematic flowchart of a method for converting neural network information according to another embodiment;

FIG. 11 is a schematic flowchart of a method for converting neural network information according to an embodiment;

FIG. 12 is a schematic flowchart of a method for converting neural network information according to another embodiment;

FIG. 13 is a schematic structural diagram of a computing core in the method for converting neural network information according to another embodiment;

FIG. 14 is a schematic flowchart of a system for converting neural network information according to an embodiment;

FIG. 15 a schematic flowchart of a system for converting neural network information according to another embodiment; and

FIG. 16 a schematic flowchart of a system for converting neural network information according to another embodiment.

### DETAILED DESCRIPTION

The present disclosure will be further described in detail below with reference to the accompanying drawings and embodiments in order to make the aim, technical solutions and advantages thereof more clear. It should be understood that the specific embodiments as described herein are merely illustrative of and are not intended to limit the present disclosure.

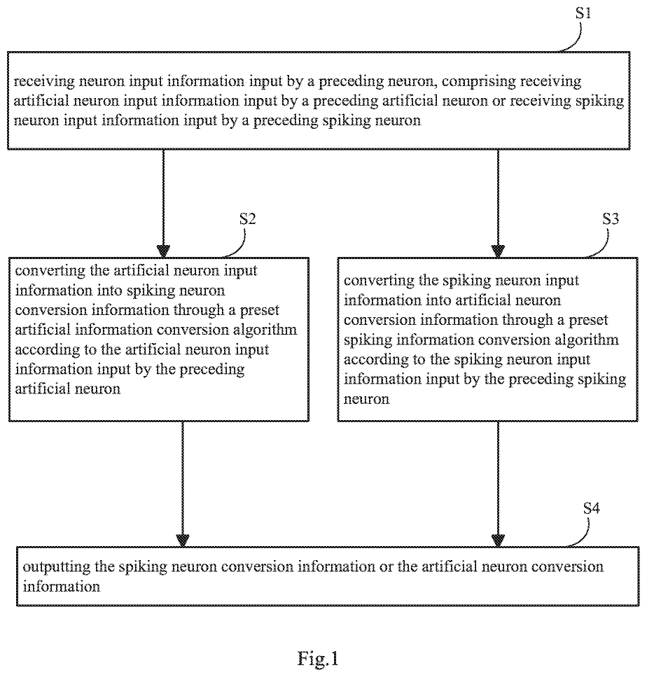

FIG. 1 is a schematic flowchart of a method for converting neural network information according to an embodiment, and the method for converting neural network information as shown in FIG. 1 includes:

Step S1: receiving neuron input information input by a preceding neuron, comprising receiving artificial neuron input information input by a preceding artificial neuron or receiving spiking neuron input information input by a preceding spiking neuron.

Specifically, the method for converting neural network information as provided in the embodiment may either convert the input artificial neuron information into the spiking neuron information or convert the input spiking neuron information into the artificial neuron information by identifying different neural network input signals.

Step S2: converting the artificial neuron input information into spiking neuron conversion information through a preset artificial information conversion algorithm according to the artificial neuron input information input by the preceding artificial neuron.

Step S3: converting the spiking neuron input information into artificial neuron conversion information through a preset spiking information conversion algorithm according to the spiking neuron input information input by the preceding spiking neuron.

Specifically, the artificial neuron information is converted into the spiking neuron information thorough a preset artificial information conversion algorithm such as emitting pulse spiking signal by comparing accumulated membrane potential with an emission threshold potential. The spiking neuron information is converted into the artificial neuron information by counting the number of pulse spiking signals in a conversion time widow.

Step S4: outputting the spiking neuron conversion information or the artificial neuron conversion information.

In the embodiment, the artificial neuron information is converted into the spiking neuron information or the spiking neuron information is converted into the artificial neuron information through a preset conversion algorithm according to received neural network information upon demand, which achieves compatibility of two different neuron information in one neural network and improves information processing capability of the neural network.

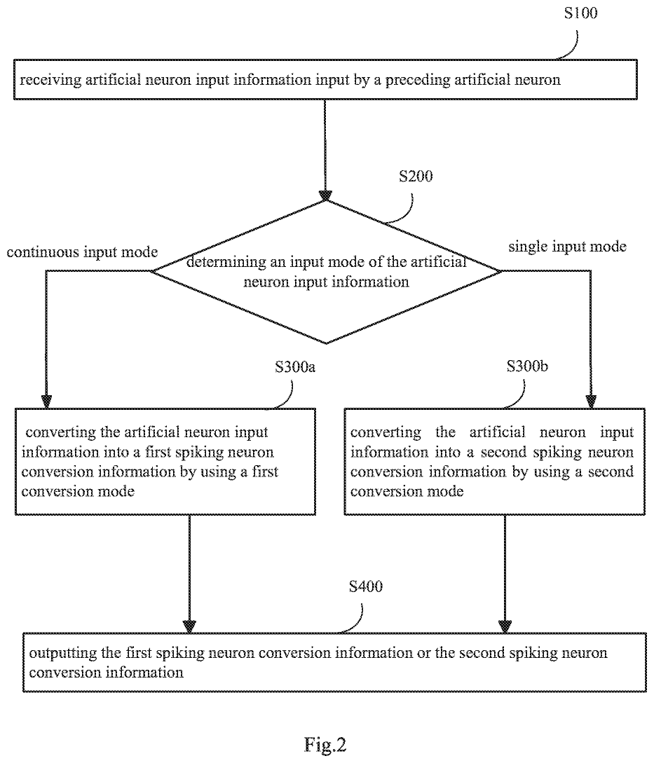

FIG. 2 is a schematic flowchart of a method for converting neural network information according to an embodiment, and method for converting neural network information as shown in FIG. 2 includes:

Step S100: receiving artificial neuron input information input by a preceding artificial neuron.

Specifically, the connection between neurons in the spiking neural network is realized by Spike (1 bit) with a certain time depth. In a certain time range, the frequency and mode of spiking firing represent different information. The connection between neurons in artificial neural network is realized by multibit quantities (e.g. 8 bits) without any time depth. When a neural network needs to process both spiking neural network information and artificial neural network information, the information output by two different neural networks are incompatible.

The received artificial neuron input information input by the preceding artificial neuron including neuron input signal realized by using multi-bit quantities (e.g. 8-bit quantities) without any time depth is the membrane potential input by the preceding artificial neuron.

Step S200: determining an input mode of the artificial neuron input information. When the input mode is a continuous input mode, it continues to Step S300a; and when the input mode is a single input mode, it continues to Step S300b.

Specifically, there are two input modes for inputting the membrane potential by the preceding artificial neuron, one is the continuous input mode in which the input of the membrane potential remains unchanged during a preset input time period, the other is the single input mode in which the input of the membrane potential is not lasting for a period of time but is a single input at a given output time.

Step S300a: converting the artificial neuron input information into a first spiking neuron conversion information by using a first conversion mode.

Specifically, the first conversion mode is used to convert the continuously input artificial neuron input information into the first spiking neuron conversion information according to the characteristics that the membrane potential is continuously input. For example, a spiking signal is emitted by an action of releasing the membrane potential higher than a preset emission threshold and the membrane potential after such release is accumulated to determine whether to continue with the release to emit a spiking signal.

Step S300b: converting the artificial neuron input information into a second spiking neuron conversion information by using a second conversion mode.

Specifically, the second conversion mode is used to convert the artificial neuron input information of the single input into the second spiking neuron conversion information by using the characteristics of the single input. For example, using a correspondence between a set spiking signal emission frequency and the artificial neuron membrane potential to determine that different emission frequencies of the spiking signal express different artificial neuron membrane potential information or using a ratio of the emission duration of the spiking signal with a fixed emission frequency in a preset time period to the duration of the preset time period to represent the artificial neuron membrane potential information.

Step S400: outputting the first spiking neuron conversion information or the second spiking neuron conversion information.

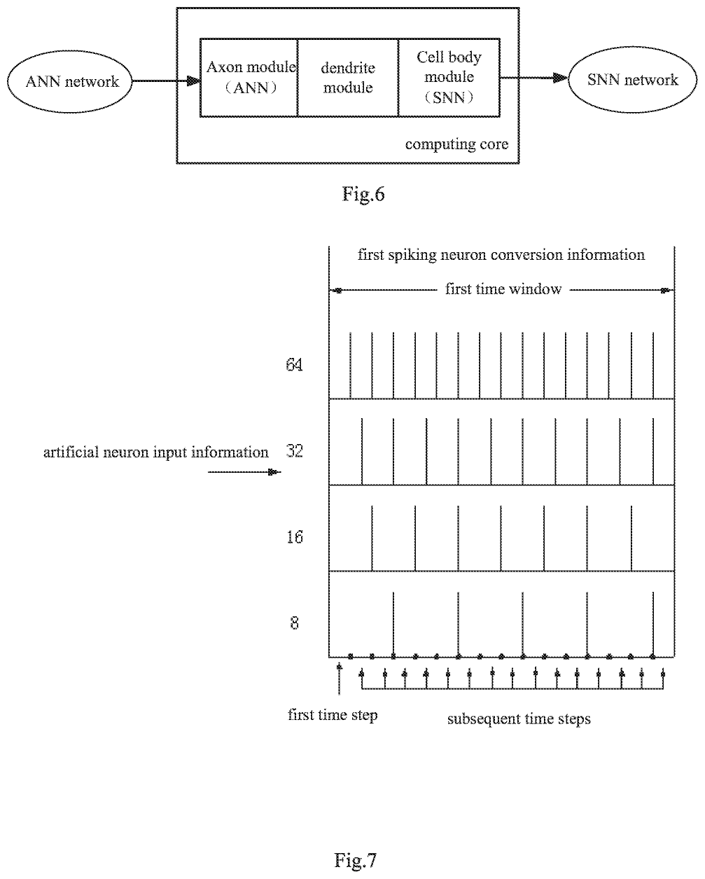

In specific implementation of the neural network, the method of the present disclosure is implemented by a computing core, as shown in FIG. 6, in which the computing core configured to receive the artificial neuron input information input by a preceding artificial neural network, convert the received artificial neuron input information into the spiking neural network information and send the spiking neural network information to a subsequent spiking neural network for use. In the computing core, the input of an axon module is used to receive the artificial neuron input information, a dendrite module is used for specifically performing accumulative calculation (including integral calculation, etc.) of the signals and a cell body module is used to send out the converted spiking neuron information. Through the calculation and processing of the computing core, the preceding artificial neural network and the subsequent spiking neural network are seamlessly connected.

In the embodiment, by determining the input mode of the received artificial neuron input information input by the preceding artificial neuron, the artificial neuron input information input in the continuous input mode or the single input mode are respectively converted into the spiking neuron information by using different conversion modes. In this embodiment, not only the artificial neuron input information can be converted into the spiking neuron information, but also the different input modes of artificial neuron input information can be compatible, which improves the compatibility of the neural network with the artificial neuron input information and the spiking neuron input information.

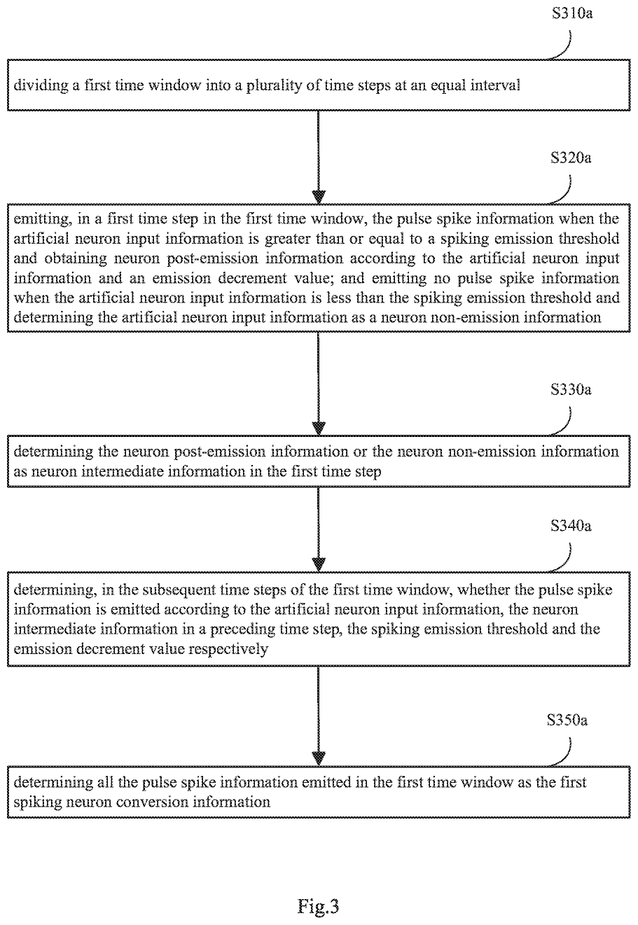

FIG. 3 is a schematic flowchart of a method for converting neural network information in the first conversion mode according to another embodiment. The method for converting neural network information as shown in FIG. 3 includes:

Step S310a: dividing a first time window into a plurality of time steps at an equal interval.

Specifically, in the first conversion mode, in order to convert the continuously input artificial neuron input information into the spiking neuron information, the time window with a first duration is divided into time steps with a second duration at an equal interval according to the characteristics of continuous input. Whether a pulse spike signal is emitted is determined in each time step and then all the pulse spike signals emitted in the first time window are determined as the converted spiking neuron information. In the conversion mode as provided in the embodiment, the converted pulse spike information also has an equal interval therebetween.

Step S320a: emitting, in a first time step of the first time window, the pulse spike information when the artificial neuron input information is greater than or equal to a spiking emission threshold and obtaining neuron post-emission information according to the artificial neuron input information and an emission decrement value; and emitting no pulse spike information when the artificial neuron input information is less than the spiking emission threshold and determining the artificial neuron input information as a neuron non-emission information;

Specifically, according to a preset spiking emission threshold, in the first time step, the pulse spike information is emitted when the artificial neuron input information is greater than or equal to the spiking emission threshold, and no pulse spike information is emitted when the artificial neuron input information is less than the spiking emission threshold.

A neuron post-emission information is obtained by subtracting an emission decrement value from the artificial neuron input information when the pulse spike information is emitted, and the membrane potential value of the neuron post-emission information is less than that of the artificial neuron input information.

The emission decrement value is not subtracted from the artificial neuron input information when no pule spike information is emitted.

As shown in FIG. 7, after dividing a time window into time steps at an equal interval, whether the pulse spike information is emitted is determined according to the relationship between the membrane potential value Vⱼ and the spiking emission threshold value Vₜₕ in a first time step:

$$Fire = \{ \begin{matrix}1 , & when {V}_{j} \geq {V}_{th} \\ 0 , & when {V}_{j} < {V}_{th}\end{matrix}$$

Wherein, Fire=1 represents that the pulse spike information is emitted, Fire=0 represents that no pulse spike information is emitted, Vⱼ is the membrane potential information in current time step j, and Vₜₕ is the spiking emission threshold.

If Fire=1, then Vₓ=Vⱼ−ΔV, wherein Vₓ is the neuron post-emission information in current time step;

If Fire=0, then V_{y}=Vⱼ, wherein V_{y} is the neuron non-emission information in current time step.

Step S330a: determining the neuron post-emission information or the neuron non-emission information as neuron intermediate information in the first time step.

Specifically, in subsequent time steps of the time window, both the neuron post-emission information and the neuron non-emission information obtained in the first time step are used as the neuron intermediate information in the first time step for participating in the calculation in the subsequent time steps.

The neuron post-emission information Vₓ and the neuron non-emission information V_{y} are used as the neuron intermediate information Vᵢ in the current time step

Step S340a: determining, in subsequent time steps of the first time window, whether the pulse spike information is emitted according to the artificial neuron input information, the neuron intermediate information in the preceding time step, the spiking emission threshold and the emission decrement value respectively.

Specifically, determining whether the pulse spike information is emitted in the subsequent time steps according to the artificial neuron input information and the neuron intermediate information in the first time step respectively.

Step S350a: determining all the pulse spike information emitted in the first time window as the first spiking neuron conversion information.

Specifically, after the completion of the actions of emission or non-emission of the pulse spike information in all time steps in a time window, all the pulse spike information emitted in the time window are determined as the first spiking neuron conversion information in the first time window.

In the embodiment, when the input mode of the artificial neuro input information is the continuous input mode, the time window is divided into time steps at an equal interval, and whether the pulse spike information is emitted is determined according to the comparison of the artificial neuron input information and the spiking emission threshold in the first time step and the neuron intermediate information in the first time step is obtained. In subsequent time steps, whether the pulse spike information is emitted is determined according to the artificial neuron input information, the spiking emission threshold and the emission decrement value. Finally, all the pulse spike information emitted in the time window is determined as the converted spiking neuron information. By the way of controlling whether the pulse spike signal is emitted according to the artificial neuron input information by using the spiking emission threshold and the emission decrement value in the time window, different spiking neuron information conversion results can be given with respect to the artificial neuron input information by adjusting the spiking emission threshold and the emission decrement value according to different requirements, which can be easily implemented.

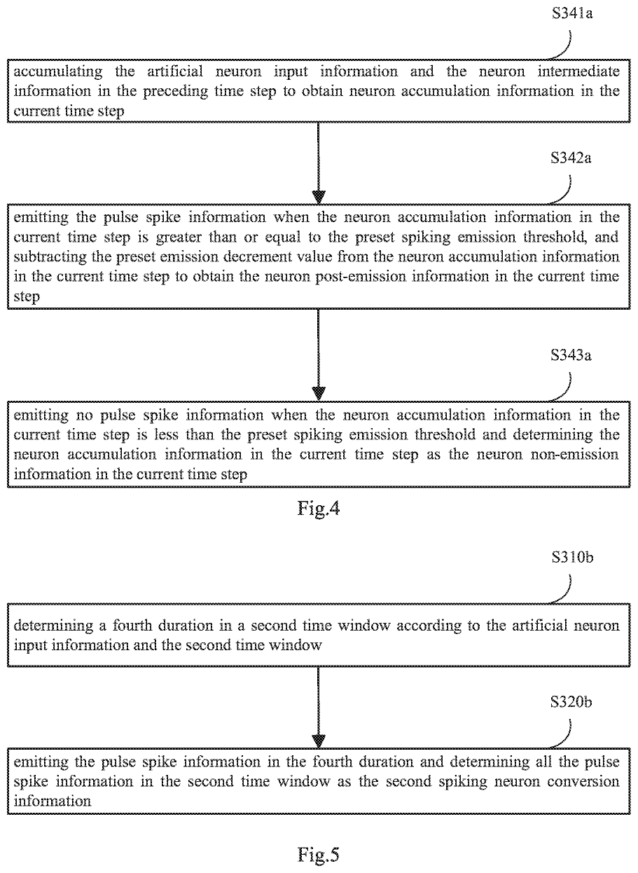

FIG. 4 is a schematic flowchart of the method for converting neural network information in subsequent time steps except for the first time step in the first time window according to an embodiment. The method for converting neural network information as shown in FIG. 4 includes:

Step S341a: accumulating the artificial neuron input information and the neuron intermediate information in the preceding time step to obtain neuron accumulation information in the current time step;

Specifically, in the subsequent time steps after the first time step, the received artificial neuron input information input by the preceding artificial neuron and the neuron intermediate information obtained in the preceding time step are accumulated to obtain the neuron accumulation information in the current time step. Since the input mode of the artificial neuron input information is continuous, the membrane potential information obtained in each time step is continuous and equal.

Whether the pulse spike information is emitted is determined according to the relationship between the received membrane potential value Vⱼ input by the preceding artificial neuron in the current time step plus with the neuron intermediate information Vᵢ in the preceding time step and the spiking emission threshold value Vₜₕ:

$$Fire = \{ \begin{matrix}1 , & when {V}_{j} + {V}_{i} \geq {V}_{th} \\ 0 , & when {V}_{j} + {V}_{i} < {V}_{th}\end{matrix}$$

Step S342a: emitting the pulse spike information when the neuron accumulation information in the current time step is greater than or equal to the preset spiking emission threshold, and subtracting the preset emission decrement value from the neuron accumulation information in the current time step to obtain the neuron post-emission information in the current time step.

Specifically, the neuron accumulation information obtained in each time step is compared with the preset spiking emission threshold, and the pulse spiking signal is emitted when the neuron accumulation information is greater than the preset spiking emission threshold and the preset emission decrement value is subtracted from the neuron accumulation information for the calculation in next time step.

Step S343a: emitting no pulse spike information when the neuron accumulation information in the current time step is less than the preset spiking emission threshold and determining the neuron accumulation information in the current time step as the neuron non-emission information in the current time step.

Specifically, the neuron accumulation information in the current time step is determined as the neuron non-emission information in the current time step and is used to participate in the calculation in the subsequent time steps when no pulse spike information is emitted.

As shown in FIG. 7, in respective time steps in a time window, a spiking signal composed of multiple pulse spike information is obtained by emitting the pulse spike information or not. The converted spiking neuron information is different due to different input artificial neuron input information and different time interval at which the pulse spike information is emitted.

In the embodiment, when the input mode of the artificial neuro input information is the continuous input mode, in the subsequent time steps except for the first time step, whether the pulse spike information is emitted is determined according to the artificial neuron input information, the spiking emission threshold and the emission decrement value. Finally, all the pulse spike information emitted in the time window is determined as the converted spiking neuron information. By the way of controlling whether the pulse spike signal is emitted according to the artificial neuron input information by using the spiking emission threshold and the emission decrement value in the time window, different spiking neuron information conversion results can be given with respect to the artificial neuron input information by adjusting the spiking emission threshold and the emission decrement value according to different requirements, which can be easily implemented.

FIG. 5 is a schematic flowchart of a method for converting neural network information in the second conversion mode according to another embodiment. The method for converting neural network information as shown in FIG. 5 includes:

Step S310b: determining a fourth duration in a second time window according to the artificial neuron input information and the second time window;

Specifically, when the input mode of the artificial neuron input information is the single input mode, the membrane potential is not continuously input and the non-continuous membrane potential information of the single input is required to be converted into the spiking neuron information.

Step S320b: emitting the pulse spike information in the fourth duration and determining all the pulse spike information in the second time window as the second spiking neuron conversion information.

Specifically, in a time window, a ratio of the duration in which the pulse spike information is emitted to the duration in which no pulse spike information is emitted is determined according to the membrane potential value of the artificial neuron input information. Emitting the pulse spike information in the fourth duration includes continuously emitting the pulse spike information or emitting pulse spike information once at the beginning and end of the fourth duration respectively. Continuously emitting the pulse spike information includes continuously emitting the pulse spike information in the fourth duration, and continuously emitting the pulse spike information includes continuously emitting the pulse spike information at an equal interval or at an unequal interval.

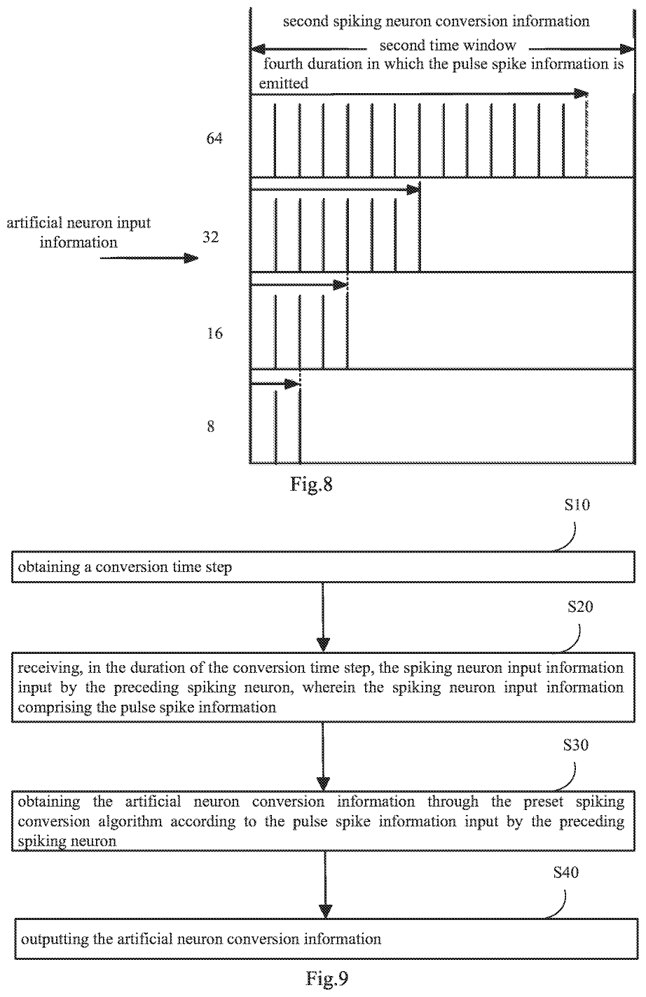

As shown in FIG. 8, the second spiking neuron conversion information is determined according to the ratio of the fourth duration to the duration of the second time window by continuously emitting the pulse spike information in the fourth duration.

In the embodiment, the duration in which the pulse spike information is emitted in a time window is determined according to the artificial neuron input information and the converted spiking neuron information is determined according to the emitted pulse spike information. In the embodiment, the converted spiking neuron information is determined by the number of the pulse spike information in a certain time window or the ratio of the duration in which the pulse spike information is emitted to the duration in the time window in which no pulse spike information is emitted, which can be easily implemented.

FIG. 9 is a schematic flowchart of a method for converting neural network information according to an embodiment, and the method for converting neural network information as shown in FIG. 9 includes:

Step S10: obtaining a conversion time step.

Specifically, the connection between neurons in the spiking neural network is realized by Spike (1 bit) with a certain time depth. In a certain time range, the frequency and mode of spiking firing represent different information. The connection between neurons in artificial neural network is realized by multibit quantities (e.g. 8 bits) without any time depth. When a neural network needs to process both spiking neural network information and artificial neural network information, the information output by two different neural networks are incompatible.

The conversion time step is a preset time period. Since the received spiking neuron input information is the information composed of pulse spike signals with time depth, the spike information with different emission number and the same emission interval or the spike information with the same emission number and different emission interval in different time periods represents different meanings. Therefore, it is necessary to set a preset time period for analyzing the pulse spike information in the preset time period in order to obtain the artificial neuron conversion information.

Step S20: receiving, in the duration of the conversion time step, the spiking neuron input information input by the preceding spiking neuron, wherein the spiking neuron input information comprising the pulse spike information.

Specifically, in an actual neural network, receiving the spiking neuron input information input by the preceding spiking neuron includes receiving a plurality of spiking neuron input information input by a plurality of preceding spiking neurons.

Step S30: obtaining the artificial neuron conversion information through the preset spiking conversion algorithm according to the pulse spike information input by the preceding spiking neuron.

Specifically, converting the pulse spike information received in the duration of a time step includes accumulating the number of the pulse spike signals or accumulating the membrane potentials of the pulse spike signals, and converting the total number of the accumulated pulse spike signals or the total membrane potential of the accumulated pulse spike signals according to the preset spiking conversion algorithm so as to obtain the artificial neuron conversion information.

Step S40: outputting the artificial neuron conversion information.

In specific implementation of the neural network, the method of the present disclosure is implemented by a computing core, as shown in FIG. 13, in which the computing core configured to receive the spiking neuron input information input by a preceding spiking neural network, convert the received spiking neuron input information into the artificial neural network information and send the artificial neural network information to a subsequent artificial neural network for use. In the computing core, the input of an axon module is used to receive the spiking neuron input information, a dendrite module is used for specifically performing accumulative calculation (including integral calculation, etc.) of the signals and a cell body module is used to send out the converted artificial neuron information. Through the calculation and processing of the computing core, the preceding spiking neural network and the subsequent artificial neural network are seamlessly connected.

In the embodiment, by acquiring the conversion time step, the spiking neuron input information is converted to the artificial neuron information according to received pulse spike information input by the preceding spiking neuron in different durations of the time steps and the preset spiking conversion algorithm. The method for converting the spiking neuron information into the artificial neuron information provided in this embodiment converts the spiking neuron information into the artificial neuron information by setting a time step, thereby improving the compatibility of the neural network with the spiking neuron information and the artificial neuron information.

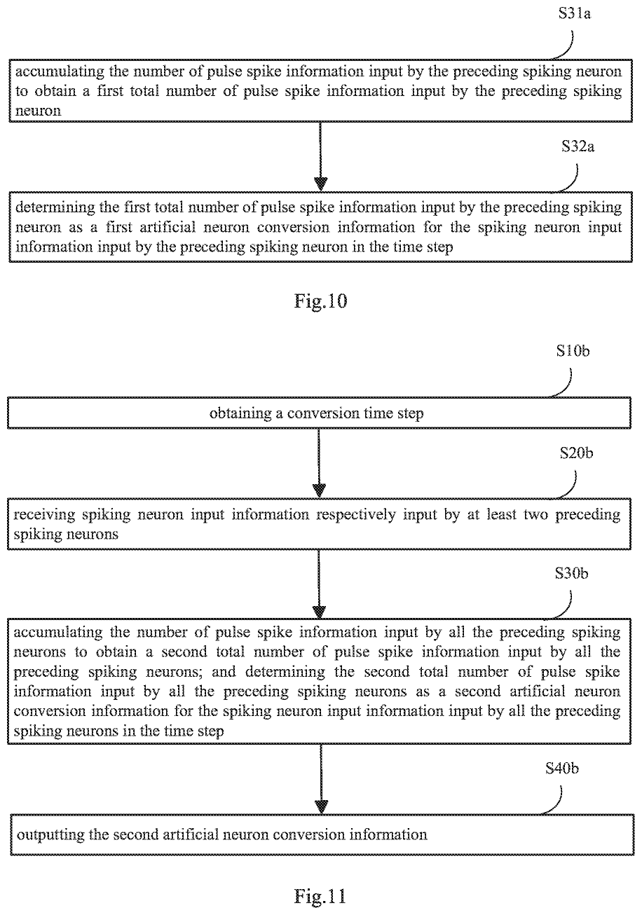

FIG. 10 is a schematic flowchart of a method for converting neural network information according to another embodiment, and method for converting neural network information as shown in FIG. 10 includes:

Step S31a: accumulating the number of pulse spike information input by the preceding spiking neuron to obtain a first total number of pulse spike information input by the preceding spiking neuron.

Specifically, the number of the received pulse spike signal is accumulated to obtain the total number of the pulse spike signal received in the duration of the time step.

Step S32a: determining the first total number of pulse spike information input by the preceding spiking neuron as a first artificial neuron conversion information for the spiking neuron input information input by the preceding spiking neuron in the time step.

Specifically, the total number can be expressed directly in the form of a number, and can also be transformed into a number in a certain range of values or a number with different precision through certain mathematical algorithms.

In the embodiment, the preceding spiking neuron information is converted into the artificial neuron conversion information by accumulating the number of pulse spike information in the conversion time step, the implementation is simple and reliable and the conversion efficiency is high.

FIG. 11 is a schematic flowchart of a method for converting neural network information according to an embodiment, and the method for converting neural network information as shown in FIG. 11 includes:

Step S10b: obtaining a conversion time step.

Specifically, Step S10b is identical to Step S100.

Step S20b: receiving spiking neuron input information respectively input by at least two preceding spiking neurons.

Step S30b: accumulating the number of pulse spike information input by all the preceding spiking neurons to obtain a second total number of pulse spike information input by all the preceding spiking neurons; and determining the second total number of pulse spike information input by all the preceding spiking neurons as a second artificial neuron conversion information for the spiking neuron input information input by all the preceding spiking neurons in the time step.

Specifically, when there are at least two preceding spiking neurons, the total number of the received pulse spike signals is obtained by accumulating the number of pulse spike signals input by the at least two preceding spiking neurons and then the total number is converted later.

It is also possible to obtain a total membrane potential value by accumulating all the membrane potentials of the spike signals input by at least two preceding spiking neurons and then convert it later.

Step S40b, outputting the second artificial neuron conversion information.

In the embodiment, with respect to the spiking neuron input information input by a plurality of preceding spiking neurons, the spiking neuron input information input by all the preceding spiking neurons is accumulated and the accumulated spiking neuron input information is converted to obtain artificial neuron conversion information for the spiking neuron input information input by all the preceding spiking neurons. The way of accumulating the spiking neuron input information input by all the preceding spiking neurons and converting the accumulated spiking neuron input information into the artificial neuron conversion information for one time is suitable for the situation where there are a large number of preceding spiking neurons, which can improve the efficiency of converting the spiking neuron input information into the artificial neuron conversion information.

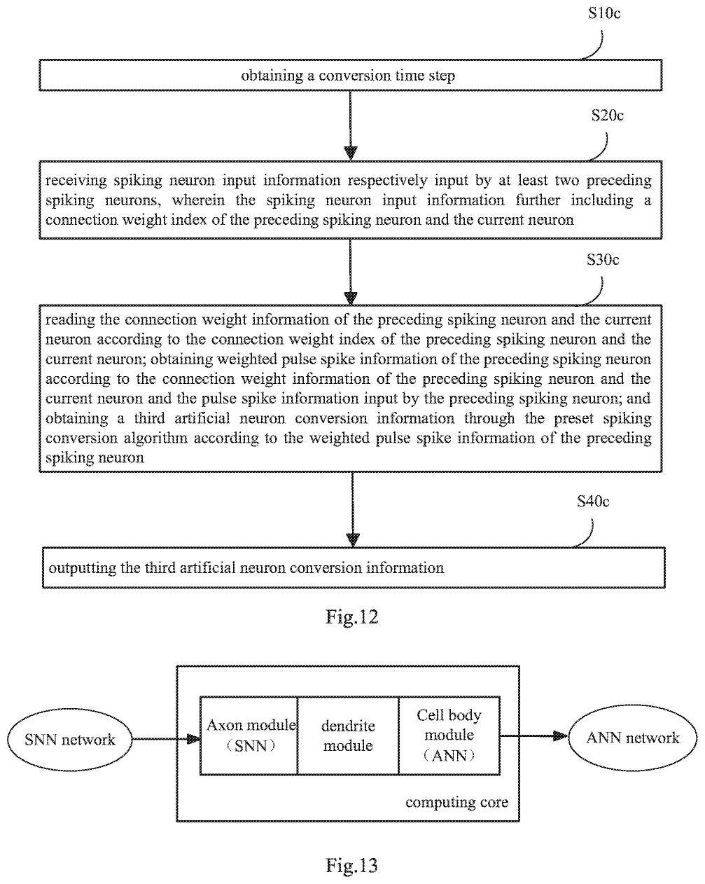

FIG. 12 is a schematic flowchart of a method for converting neural network information according to another embodiment, and the method for converting neural network information as shown in FIG. 12 includes:

Step S10c: obtaining a conversion time step.

Specifically, Step S10c is identical to Step S100.

Step S20c: receiving spiking neuron input information respectively input by at least two preceding spiking neurons, wherein the spiking neuron input information further includes a connection weight index of the preceding spiking neuron and the current neuron.

Specifically, the connection weight index of the preceding spiking neuron and the current neuron is an index value for the weight information of the preceding spiking neuron information in the calculation for the current neuron. By the way of indexing the weight, a smaller information transfer space is needed for the information transfer process, which not only reduces the processing requirements for the hardware, but also can update the change of the weight information more flexibly and conveniently by changing the index information, which makes the update of the weight information in the neural network more convenient.

Step S30c: reading the connection weight information of the preceding spiking neuron and the current neuron according to the connection weight index of the preceding spiking neuron and the current neuron; obtaining weighted pulse spike information of the preceding spiking neuron according to the connection weight information of the preceding spiking neuron and the current neuron and the pulse spike information input by the preceding spiking neuron; and obtaining a third artificial neuron conversion information through the preset spiking conversion algorithm according to the weighted pulse spike information of the preceding spiking neuron.

Specifically, the connection weight index information can be stored either locally in the current neuron or elsewhere in the neural network as long as the current neuron can read it. After receiving the spiking neuron input information carrying the connection weight index input by a plurality of preceding spiking neurons, the connection weigh information of a single preceding spiking neuron is read and then calculated with the respectively received pulse spike information to obtain the spiking neuron input information input the single preceding spiking neuron. That is, the connection weigh information needs to be calculated with the pulse spike information before converting the spiking neuron input information input by the single preceding spiking neuron into the artificial neuron conversion information.

Step S40c: outputting the third artificial neuron conversion information.

In the embodiment, the received preceding spiking neuron information respectively carries a connection weight index. With respect to the spiking neuron input information carrying the connection weight index input by the plurality of preceding spiking neurons, the pulse spike information input by the single preceding spiking neuron is calculated with its connection weight information to obtain the artificial neuron conversion information for the spiking neuron input information input by the single preceding spiking neuron, which can ensure that the information conversion process does not influence the final calculation.

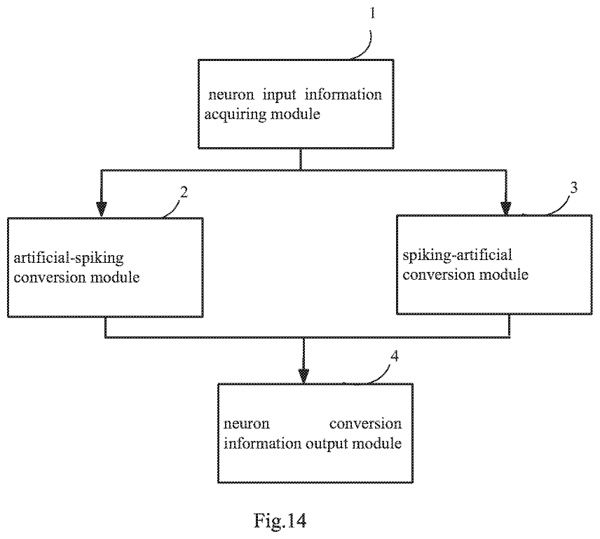

FIG. 14 is a schematic flowchart of a system for converting neural network information according to an embodiment, and the system for converting neural network information as shown in FIG. 14 includes:

a neuron input information acquiring module 1 configured to receive neuron input information input by a preceding neuron, comprising receiving artificial neuron input information input by a preceding artificial neuron or receiving spiking neuron input information input by a preceding spiking neuron;

an artificial-spiking conversion module 2 configured to convert the artificial neuron input information into spiking neuron conversion information through a preset artificial information conversion algorithm according to the artificial neuron input information input by the preceding artificial neuron;

a neuron conversion information output module 4 configure to output the spiking neuron conversion information; or

a spiking-artificial conversion module 3 configure to convert the spiking neuron input information into artificial neuron conversion information through a preset spiking information conversion algorithm according to the spiking neuron input information input by the preceding spiking neuron, and

wherein the neuron conversion information output module 4 configured to output the artificial neuron conversion information.

In the embodiment, the artificial neuron information is converted into the spiking neuron information or the spiking neuron information is converted into the artificial neuron information through the preset conversion algorithm according to received neural network information upon demand, which realizes the compatibility of two different neuron information in one neural network and improves the information processing capability of the neural network.

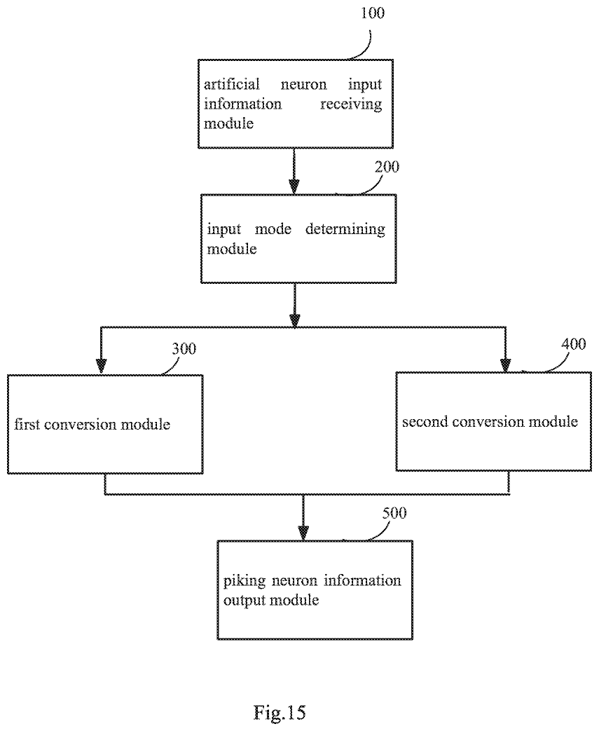

FIG. 15 is a schematic flowchart of a system for converting neural network information according to another embodiment, and the system for converting neural network information as shown in FIG. 15 includes:

an artificial neuron input information receiving module 100 configured to receive artificial neuron input information input by a preceding artificial neuron;

an input mode determining module 200 configured to determine an input mode of the artificial neuron input information;

a first conversion module 300 configured to convert the artificial neuron input information into a first spiking neuron conversion information by using a first conversion mode when the input mode is a continuous input mode,

a second conversion module 400 configured to convert the artificial neuron input information into a second spiking neuron conversion information by using a second conversion mode when the input mode is a single input mode. Specifically, the second conversion module 400 is configured to determine a fourth duration in a second time window according to the artificial neuron input information and the second time window, to emit pulse spike information in the fourth duration, and to determine all the pulse spike information in the second time window as the second spiking neuron conversion information, wherein emitting pulse spike information in the fourth duration comprising continuously emitting pulse spike information in the fourth duration.

a spiking neuron information output module 500 configured to output the first spiking neuron conversion information or the second spiking neuron conversion information.

In the embodiment, by determining the input mode of the received artificial neuron input information input by the preceding artificial neuron, the artificial neuron input information input in the continuous input mode or the single input mode are respectively converted into the spiking neuron information by using different conversion modes. In this embodiment, not only the artificial neuron input information can be converted into the spiking neuron information, but also the different input modes of artificial neuron input information can be compatible, which improves the compatibility of the neural network with the artificial neuron input information and the spiking neuron input information. Further, the duration in which the pulse spike information is emitted in a time window is determined according to the artificial neuron input information and the spiking neuron conversion information is determined according to the emitted pulse spike information. In the embodiment, the spiking neuron conversion information is determined by the number of the pulse spike information in a certain time window or the ratio of the duration in which the pulse spike information is emitted to the duration in the time window in which no pulse spike information is emitted, which can be easily implemented.

In one embodiment, the first conversion module includes:

a time dividing unit configured to divide a first time window into a plurality of time steps at an equal interval;

a first time step processing unit configured to, in a first time step of the first time window, emit the pulse spike information when the artificial neuron input information is greater than or equal to a spiking emission threshold, and obtain neuron post-emission information according to the artificial neuron input information and an emission decrement value; to emit no pulse spike information when the artificial neuron input information is less than the spiking emission threshold and determine the artificial neuron input information as a neuron non-emission information; and to determine the neuron post-emission information or the neuron non-emission information as neuron intermediate information in the first time step;

a subsequent time step processing unit configured to determine, in subsequent time steps of the first time window, whether the pulse spike information is emitted according to the artificial neuron input information, the neuron intermediate information in a preceding time step, the spiking emission threshold and the emission decrement value respectively; to accumulate the artificial neuron input information and the neuron intermediate information obtained in the preceding time step to obtain neuron accumulation information in the current time step; to emit the pulse spike information when the neuron accumulation information in the current time step is greater than or equal to the preset spiking emission threshold, and subtract the preset emission decrement value from the neuron accumulation information in the current time step to obtain the neuron post-emission information in the current time step; and to emit no pulse spike information when the neuron accumulation information in the current time step is less than the preset spiking emission threshold and determine the neuron accumulation information in the current time step as the neuron non-emission information in the current time step; and

a first spiking neuron conversion information determining unit configured to determine all pulse spike information emitted in the first time window as the first spiking neuron conversion information.

In the embodiment, when the input mode of the artificial neuro input information is the continuous input mode, the time window is divided into time steps at an equal interval, and whether the pulse spike information is emitted is determined according to the comparison of the artificial neuron input information and the spiking emission threshold in the first time step and the neuron intermediate information in the first time step is obtained. In subsequent time steps, whether the pulse spike information is emitted is determined according to the artificial neuron input information, the spiking emission threshold and the emission decrement value. Finally, all the pulse spike information emitted in the time window is determined as the converted spiking neuron information. By the way of controlling whether the pulse spike signal is emitted according to the artificial neuron input information by using the spiking emission threshold and the emission decrement value in the time window, different spiking neuron information conversion results can be given with respect to the artificial neuron input information by adjusting the spiking emission threshold and the emission decrement value according to different requirements, which can be easily implemented.

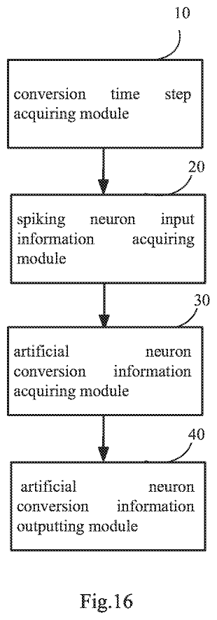

FIG. 16 is a schematic flowchart of a system for converting neural network information according to another embodiment, and the system for converting neural network information as shown in FIG. 16 includes:

a conversion time step acquiring module 10 configured to obtain a conversion time step;

a spiking neuron input information acquiring module 20 configured to receive, in the duration of the conversion time step, the spiking neuron input information input by the preceding spiking neuron, wherein the spiking neuron input information comprising the pulse spike information; and to receive the spiking neuron input information respectively input by at least two preceding spiking neurons;

an artificial neuron conversion information acquiring module 30 configured to obtain the artificial neuron conversion information through the preset spiking conversion algorithm according to the pulse spike information input by the preceding spiking neuron, comprising: a preceding spiking neuron pulse spike information acquiring unit configured to accumulate the number of pulse spike information input by the preceding spiking neuron to obtain a first total number of pulse spike information input by the preceding spiking neuron, wherein the spiking neuron input information further comprising a connection weight index of the preceding spiking neuron and the current neuron; a first artificial neuron conversion information acquiring unit configured to determine the first total number of pulse spike information input by the preceding spiking neuron as a first artificial neuron conversion information for the spiking neuron input information input by the preceding spiking neuron in the time step, wherein the artificial neuron conversion information acquiring module 30 further comprising a multi-preceding spiking neuron pulse spike information acquiring unit configured to accumulate the number of pulse spike information input by all the preceding spiking neurons to obtain a second total number of pulse spike information input by all the preceding spiking neurons; a second artificial neuron conversion information acquiring unit configured to determine the second total number of pulse spike information input by all the preceding spiking neurons as a second artificial neuron conversion information for the spiking neuron input information input by all the preceding spiking neurons in the time step; a weighted preceding spiking neuron acquiring unit configured to read the connection weight information of the preceding spiking neuron and the current neuron according to the connection weight index of the preceding spiking neuron and the current neuron, and obtain weighted pulse spike information of the preceding spiking neuron according to the connection weight information of the preceding spiking neuron and the current neuron and the pulse spike information input by the preceding spiking neuron; and a third artificial neuron conversion information acquiring unit configured to obtain a third artificial neuron conversion information through the preset spiking conversion algorithm according to the weighted pulse spike information of the preceding spiking neuron; and

an artificial neuron conversion information outputting module 40 configured to output the artificial neuron conversion information.

In the embodiment, by acquiring the conversion time step, the spiking neuron input information is converted to the artificial neuron information according to received pulse spike information input by the preceding spiking neuron in different durations of the time steps and the preset spiking conversion algorithm. The method for converting the spiking neuron information into the artificial neuron information provided in this embodiment converts the spiking neuron information into the artificial neuron information by setting a time step, thereby improving the compatibility of the neural network with the spiking neuron information and the artificial neuron information.

In the embodiment, the spiking neuron input information input by the preceding spiking neuron information is converted into the artificial neuron conversion information by accumulating the number of pulse spike information in the conversion time step, the implementation is simple and reliable and the conversion efficiency is high. With respect to the spiking neuron input information input by a plurality of preceding spiking neurons, the artificial neuron conversion information for the spiking neuron input information input by the plurality of preceding spiking neurons are obtained by respectively converting the spiking neuron input information input by a single preceding spiking neuron into the artificial neuron conversion information, so that the current neuron may be used for subsequent calculations. The way of respectively converting the spiking neuron input information input by a single preceding spiking neuron into the artificial neuron conversion information is suitable for the situation where the number of the preceding spiking neurons is not too large, and the artificial neuron conversion information for the converted single preceding spiking neuron does not have any influence on the calculation for the current neurons. Further, with respect to the spiking neuron input information input by a plurality of preceding spiking neurons, the spiking neuron input information input by all the preceding spiking neurons is accumulated and the accumulated spiking neuron input information is converted to obtain artificial neuron conversion information for the spiking neuron input information input by all the preceding spiking neurons. The way of accumulating the spiking neuron input information input by all the preceding spiking neurons and converting the accumulated spiking neuron input information into the artificial neuron conversion information for one time is suitable for the situation where there are a large number of preceding spiking neurons, which can improve the efficiency of converting the spiking neuron input information into the artificial neuron conversion information. Furthermore, the received preceding spiking neuron input information respectively carries a connection weight index. With respect to the spiking neuron input information carrying the connection weight index input by the plurality of preceding spiking neurons, the pulse spike information input by the single preceding spiking neuron is calculated with its connection weight information to obtain the artificial neuron conversion information for the spiking neuron input information input by the single preceding spiking neuron, which can ensure that the information conversion process does not influence the final calculation

Based on the same inventive idea, according to an embodiment of the disclosure, a computer device is provided that includes a memory, a processor, and a computer program stored on the memory and operable on the processor, wherein the processor executes the computer program to implement the steps of any of the above embodiments.

It can be understood by those skilled in the art that all or part of the processes in the method for implementing the above embodiments can be accomplished by computer programs or hardware related to instructions, and the programs can be stored in a computer-readable storage medium, which, when executed, may include the processes of the embodiments of the above-mentioned methods. Wherein, any reference to memory, storage, database or other medium used in the embodiments provided herein may include non-volatile and/or volatile memory. Non-volatile memory may include read-only memory (ROM), programmable ROM (PROM), electrically programmable ROM (EPROM), electrically erasable programmable ROM (EEPROM) or flash memory. Volatile memory may include random access memory (RAM) or external cache memory. As illustrative rather than restrictive, RAM may be available in many forms, such as Static RAM (SRAM), Dynamic RAM (DRAM), Synchronous RAM (SDRAM), Double Data Rate SDRAM (DDRSDRAM), Enhanced SDRAM (ESDRAM), Synchlink DRAM (SLDRAM), Rambus, Direct RAM (RDRAM), Direct Rambus Dynamic RAM (DRDRAM), Rambus Dynamic RAM (RDRAM) and so on.

The above-mentioned embodiments that are specifically described in details only express several embodiments of the present disclosure and therefore cannot be understood as a limitation to the protection scope of the present disclosure. It should be noted that, for those skilled in the art, a variety of variation and modifications can be made without departing from the concept of the present disclosure, which belongs to the protection scope of the present disclosure. Therefore, the protection scope of the present disclosure shall be defined by the appended claims.

1. A method for converting neural network information in neuromorphic circuit, comprising:
receiving neuron input information input by a preceding neuron, comprising receiving artificial neuron input information input by a preceding artificial neuron or receiving spiking neuron input information input by a preceding spiking neuron;
converting the artificial neuron input information into spiking neuron conversion information through a preset artificial information conversion algorithm according to the artificial neuron input information input by the preceding artificial neuron; and
outputting the spiking neuron conversion information; or
converting the spiking neuron input information into artificial neuron conversion information through a preset spiking information conversion algorithm according to the spiking neuron input information input by the preceding spiking neuron, and
outputting the artificial neuron conversion information.

2. The method according to claim 1, wherein converting the artificial neuron input information into spiking neuron conversion information through a preset artificial information conversion algorithm according to the artificial neuron input information input by the preceding artificial neuron comprising:
determining an input mode of the artificial neuron input information;
converting the artificial neuron input information into a first spiking neuron conversion information by using a first conversion mode when the input mode is a continuous input mode, wherein outputting the spiking neuron conversion information comprising outputting the first spiking neuron conversion information; and
converting the artificial neuron input information into a second spiking neuron conversion information by using a second conversion mode when the input mode is a single input mode, wherein outputting the spiking neuron conversion information comprising outputting the second spiking neuron conversion information.

3. The method according to claim 2, wherein converting the artificial neuron input information into a first spiking neuron conversion information by using a first conversion mode when the input mode is a continuous input mode comprising:
dividing a first time window into a plurality of time steps at an equal interval;
emitting, in a first time step of the first time window, pulse spike information when the artificial neuron input information is greater than or equal to a preset spiking emission threshold and obtaining neuron post-emission information according to the artificial neuron input information and a preset emission decrement value, and emitting no pulse spike information when the artificial neuron input information is less than the preset spiking emission threshold and determining the artificial neuron input information as neuron non-emission information;
determining the neuron post-emission information or the neuron non-emission information as neuron intermediate information in the first time step;
determining, in subsequent time steps of the first time window, whether the pulse spike information is emitted according to the artificial neuron input information, the neuron intermediate information in a preceding time step, the preset spiking emission threshold and the preset emission decrement value respectively; and
determining all the pulse spike information emitted in the first time window as the first spiking neuron conversion information.

4. The method according to claim 3, wherein determining whether the pulse spike information is emitted according to the artificial neuron input information, the neuron intermediate information in a preceding time step, the preset spiking emission threshold and the preset emission decrement value respectively comprising:
accumulating the artificial neuron input information and the neuron intermediate information in the preceding time step to obtain neuron accumulation information in current time step;
emitting the pulse spike information when the neuron accumulation information in the current time step is greater than or equal to the preset spiking emission threshold, and subtracting the preset emission decrement value from the neuron accumulation information in the current time step to obtain neuron post-emission information in the current time step; and
emitting no pulse spike information when the neuron accumulation information in the current time step is less than the preset spiking emission threshold and determining the neuron accumulation information in the current time step as neuron non-emission information in the current time step.

5. The method according to claim 2, wherein converting the artificial neuron input information into a second spiking neuron conversion information by using a second conversion mode when the input mode is a single input mode comprising:
determining a fourth duration in a second time window according to the artificial neuron input information and the second time window; and
emitting the pulse spike information in the fourth duration and determining all the pulse spike information in the second time window as the second spiking neuron conversion information.

6. The method according to claim 5, wherein emitting the pulse spike information in the fourth duration comprising:
continuously emitting the pulse spike information in the fourth duration.

7. The method according to claim 1, wherein converting the spiking neuron input information into the artificial neuron conversion information through the preset spiking information conversion algorithm according to the spiking neuron input information comprising:
obtaining a conversion time step;
receiving, in the duration of the conversion time step, the spiking neuron input information input by the preceding spiking neuron, wherein the spiking neuron input information comprising the pulse spike information;
obtaining the artificial neuron conversion information through the preset spiking conversion algorithm according to the pulse spike information input by the preceding spiking neuron; and
outputting the artificial neuron conversion information.

8. The method according to claim 7, wherein obtaining the artificial neuron conversion information through the preset spiking conversion algorithm according to the pulse spike information input by the preceding spiking neuron comprising:
accumulating the number of the pulse spike information input by the preceding spiking neuron to obtain a first total number of the pulse spike information input by the preceding spiking neuron; and
determining the first total number of the pulse spike information input by the preceding spiking neuron as a first artificial neuron conversion information for the spiking neuron input information input by the preceding spiking neuron in the time step.

9. The method according to claim 7, wherein receiving the spiking neuron input information input by the preceding spiking neuron further comprising:
receiving the spiking neuron input information respectively input by at least two preceding spiking neurons;
wherein obtaining the artificial neuron conversion information through the preset spiking conversion algorithm according to the pulse spike information input by the preceding spiking neuron further comprising:
accumulating the number of pulse spike information input by all the preceding spiking neurons to obtain a second total number of pulse spike information input by all the preceding spiking neurons; and
determining the second total number of pulse spike information input by all the preceding spiking neurons as a second artificial neuron conversion information for the spiking neuron input information input by all the preceding spiking neurons in the time step.

10. The method according to claim 7, wherein the spiking neuron input information further comprising:
a connection weight index of the preceding spiking neuron and the current neuron;
wherein obtaining the artificial neuron conversion information through the preset spiking conversion algorithm according to the pulse spike information input by the preceding spiking neuron further comprising:
reading the connection weight information of the preceding spiking neuron and the current neuron according to the connection weight index of the preceding spiking neuron and the current neuron;
obtaining weighted pulse spike information of the preceding spiking neuron according to the connection weight information of the preceding spiking neuron and the current neuron and the pulse spike information input by the preceding spiking neuron; and
obtaining a third artificial neuron conversion information through the preset spiking conversion algorithm according to the weighted pulse spike information of the preceding spiking neuron.

11. A method for converting spiking neural network information into artificial neural network information comprising:
obtaining a conversion time step;
receiving, in the duration of the conversion time step, spiking neuron input information input by a preceding spiking neuron, wherein the spiking neuron input information comprising pulse spike information;
obtaining artificial neuron conversion information through a preset spiking conversion algorithm according to the pulse spike information input by the preceding spiking neuron; and
outputting the artificial neuron conversion information.

12. A method for converting artificial neuron information into spiking neuron information comprising:
receiving artificial neuron input information input by a preceding artificial neuron;
determining an input mode of the artificial neuron input information;
converting the artificial neuron input information into a first spiking neuron information by using a first conversion mode when the input mode is a continuous input mode, and outputting the first spiking neuron information; and
converting the artificial neuron input information into a second spiking neuron information by using a second conversion mode when the input mode is a single input mode, and outputting the second spiking neuron information.

13. A computer device comprising a memory, a processor, and a computer program stored on the memory and operable on the processor, the processor executing the computer program to implement the steps of the method according to any of claims 1-12.

14. A system for converting neural network information comprising:
a neuron input information acquiring module configured to receive neuron input information input by a preceding neuron, comprising receiving artificial neuron input information input by a preceding artificial neuron or receiving spiking neuron input information input by a preceding spiking neuron;
an artificial-spiking conversion module configured to convert the artificial neuron input information into spiking neuron conversion information through a preset artificial information conversion algorithm according to the artificial neuron input information input by the preceding artificial neuron;
a neuron conversion information output module configured to output the spiking neuron conversion information; or
a spiking-artificial conversion module configured to convert the spiking neuron input information into artificial neuron conversion information through a preset spiking information conversion algorithm according to the spiking neuron input information input by the preceding spiking neuron, and
wherein the neuron conversion information output module configured to output the artificial neuron conversion information.

15. A system for converting spiking neural network information into artificial neural network information comprising:
a conversion time step acquiring module configured to obtain a conversion time step;
a spiking neuron input information acquiring module configured to receive, in the duration of the conversion time step, spiking neuron input information input by a preceding spiking neuron, wherein the spiking neuron input information comprising pulse spike information;
an artificial neuron conversion information acquiring module configured to obtain artificial neuron conversion information through a preset spiking conversion algorithm according to the pulse spike information input by the preceding spiking neuron; and
an artificial neuron conversion information output module configured to output the artificial neuron conversion information.

16. A system for converting artificial neuron information into spiking neuron information comprising:
an artificial neuron input information receiving module configured to receive artificial neuron input information input by a preceding artificial neuron;
an input mode determining module configured to determine an input mode of the artificial neuron input information;
a first conversion module configured to convert the artificial neuron input information into a first spiking neuron information by using a first conversion mode when the input mode is a continuous input mode,
a spiking neuron information output module configured to output the first spiking neuron information; and
a second conversion module configured to convert the artificial neuron input information into a second spiking neuron information by using a second conversion mode when the input mode is a single input mode,
wherein the piking neuron information output module configured to output the second spiking neuron information.
